(19) United States
(12) Patent Application Publication
(10) Pub. No.: US 2025/0356630 A1
(43) Pub. Date: Nov. 20, 2025

(54) IMAGE PROCESSING DEVICE, IMAGE PROCESSING METHOD, AND IMAGE PROCESSING PROGRAM

(71) Applicant: NIPPON TELEGRAPH AND TELEPHONE CORPORATION, Tokyo (JP)

(72) Inventors: Ken NAKAMURA, Tokyo (JP); Yuya OMORI, Tokyo (JP); Hiroyuki UZAWA, Tokyo (JP); Daisuke KOBAYASHI, Tokyo (JP); Saki HATTA, Tokyo (JP); Shuhei YOSHIDA, Tokyo (JP); Yuko IINUMA, Tokyo (JP)

(73) Assignee: NIPPON TELEGRAPH AND TELEPHONE CORPORATION, Tokyo (JP)

(21) Appl. No.: 18/872,216

(22) PCT Filed: Jun. 16, 2022
(86) PCT No.: PCT/JP2022/024149

§ 371 Date: Dec. 5, 2024

(51) Int. Cl. G06V 10/771; G06T 5/20; G06V 10/82

(52) U.S. Cl. CPC G06V 10/771; G06T 5/20; G06V 10/82

(57) ABSTRACT

An image processing apparatus includes: an acquisition unit configured to acquire a moving image to be processed; a difference determination unit configured to determine a difference area from a past frame for frames other than a key frame among a plurality of frames; a block setting unit configured to set, for the frames other than the key frame among the plurality of frames, an update block including an update area according to the difference area among a plurality of blocks obtained by dividing an output feature map for each of a plurality of layers to be subjected to convolution processing of a neural network; and a processing unit configured to process, for the key frame among the plurality of frames, the key frame using the neural network on the update block, and store an output feature map of each layer, and perform, for the frames other than the key frame among the plurality of frames, processing using the neural network, and overwrite an output feature map stored for the update block, and the block setting unit sets the difference area for each layer to be subjected to the convolution processing so that the difference area is expanded to a surrounding area from a previous layer according to parameters of the convolution processing, and sets the update block including the update area according to the difference area.

### TECHNICAL FIELD

The technology of the present disclosure relates to an image processing apparatus, an image processing method, and an image processing program.

### BACKGROUND ART

Inference processing such as object detection, pose estimation, and segmentation using convolutional neural network (CNN) is basically processing for one piece of image data, and when the processing is applied to each frame of a video, the amount of calculation proportional to the number of frames is required.

On the other hand, in inference processing for video data, such as video scene understanding and object tracking, the amount of calculation is suppressed by limiting applicable frames while using the above-mentioned inference processing for image data, and also using other information that can be derived with a smaller amount of calculation. However, for videos with rapid changes from frame to frame, it is desirable to perform inference processing on more frame images.

As a method for reducing the amount of calculation in this case, there is a method in which changes between frames are determined for each partial area of a video and CNN inference processing is performed only on the partial area where the change occurs, but there is a problem in that it is difficult to perform inference across partial areas.

Furthermore, NPL 1 proposes a method for reducing the amount of calculation by taking the inter-frame difference for each pixel in each layer and performing a convolution calculation.

### CITATION LIST

### Non Patent Literature

[NPL 1] Z, Yuan, et al. Tsinghua University, “A 65 nm 24.7 μJ/Frame 12.3 mW Activation-Similarity-Aware Convolutional Neural Network Video Processor Using Hybrid Precision, Inter-Frame Data Reuse and Mixed-Bit-Width Difference-Frame Data Codec,” ISSCC 2020

### SUMMARY OF INVENTION

### Technical Problem

The technology described in NPL 1 has a problem in that it requires a complicated calculation and control mechanism.

The disclosed technology has been made in view of the above points, and aims to provide an image processing apparatus, an image processing method, and an image processing program that have a simple configuration and can suppress the amount of calculation of processing using a neural network including convolution processing.

### Solution to Problem

According to a first aspect of the present disclosure, there is provided an image processing apparatus including a neural network including convolution processing for a moving image including a plurality of frames, the image processing apparatus including: an acquisition unit configured to acquire a moving image to be processed; a difference determination unit configured to determine a difference area from a past frame for frames other than a key frame among the plurality of frames; a block setting unit configured to set, for the frames other than the key frame among the plurality of frames, an update block including an update area according to the difference area among a plurality of blocks obtained by dividing an output feature map for each of a plurality of layers to be subjected to the convolution processing of the neural network; and a processing unit configured to process, for the key frame among the plurality of frames, the key frame using the neural network, and store an output feature map of each layer, and process, for the frames other than the key frame among the plurality of frames, the frames using the neural network, and overwrite an output feature map stored for the update block, in which the block setting unit sets the difference area for each layer to be subjected to the convolution processing so that the difference area is expanded to a surrounding area from a previous layer according to parameters of the convolution processing, and sets the update block including the update area according to the difference area.

According to a second aspect of the present disclosure, there is provided an image processing apparatus including a neural network including convolution processing for a moving image including a plurality of frames, the image processing apparatus including: an acquisition unit configured to acquire a moving image to be processed; a difference determination unit configured to determine a difference area from a past frame for frames other than a key frame among the plurality of frames; a block setting unit configured to set, for the frames other than the key frame among the plurality of frames, an update block including an update area according to the difference area among a plurality of blocks obtained by dividing an output feature map for each of predetermined storage layers among a plurality of layers to be subjected to the convolution processing of the neural network, and set a processing target block including a processing target area according to the difference area for each of the plurality of layers; and a processing unit configured to process, for the key frame among the plurality of frames, the key frame using the neural network, and store an output feature map of each of the storage layers, and perform, for the frames other than the key frame among the plurality of frames, processing using the neural network on the processing target block for each of the plurality of layers, and overwrite the update block of the output feature map stored for each of the storage layers, in which the block setting unit sets the difference area for each of the storage layers so that the difference area is expanded to a surrounding area from a previous layer according to parameters of the convolution processing, and sets the update block including the update area according to the difference area.

According to a third aspect of the present disclosure, there is provided an image processing method in an image processing apparatus including a neural network including convolution processing for a moving image including a plurality of frames, the image processing method including: acquiring, by an acquisition unit, a moving image to be processed; determining, by a difference determination unit, a difference area from a past frame for frames other than a key frame among the plurality of frames; setting, by a block setting unit, for the frames other than the key frame among the plurality of frames an update block including an update area according to the difference area among a plurality of blocks obtained by dividing an output feature map for each of a plurality of layers to be subjected to the convolution processing of the neural network; processing, by a processing unit, for the key frame among the plurality of frames, the key frame using the neural network, and storing an output feature map of each layer; and processing, by the processing unit, for the frames other than the key frame among the plurality of frames, the frames using the neural network, and overwriting the output feature map stored for the update block, in which the setting of the block setting unit includes setting the difference area for each layer to be subjected to the convolution processing so that the difference area is expanded to a surrounding area from a previous layer according to parameters of the convolution processing, and setting the update block including the update area according to the difference area.

According to a fourth aspect of the present disclosure, there is provided an image processing method in an image processing apparatus including a neural network including convolution processing for a moving image including a plurality of frames, the image processing method including: acquiring, by an acquisition unit, a moving image to be processed; determining, by a difference determination unit, a difference area from a past frame for frames other than a key frame among the plurality of frames; setting, by a block setting unit, for the frames other than the key frame among the plurality of frames, an update block including an update area according to the difference area among a plurality of blocks obtained by dividing an output feature map for each of predetermined storage layers among a plurality of layers to be subjected to the convolution processing of the neural network, and setting a processing target block including a processing target area according to the difference area for each of the plurality of layers; processing, by a processing unit, for the key frame among the plurality of frames, the key frame using the neural network, and storing an output feature map of each of the storage layers; and performing, by the processing unit, for the frames other than the key frame among the plurality of frames, processing using the neural network on the processing target block for each of the plurality of layers, and overwriting the update block of the output feature map stored for each of the storage layers, in which the setting of the block setting unit includes setting the difference area for each of the storage layers so that the difference area is expanded to a surrounding area from a previous layer according to parameters of the convolution processing, and setting the update block including the update area according to the difference area.

According to a fifth aspect of the present disclosure, there is provided an image processing program for causing a computer to function as the image processing apparatus according to the first aspect or the second aspect.

### Advantageous Effects of Invention

According to the disclosed technology, it is possible to suppress the amount of calculation of processing using a neural network including convolution processing with a simple configuration.

### BRIEF DESCRIPTION OF DRAWINGS

FIG. 1 is a schematic block diagram of an example of a computer that functions as an image processing apparatus according to a first embodiment and a second embodiment.

FIG. 2 is a block diagram showing a functional configuration of the image processing apparatus according to the first embodiment and the second embodiment.

FIG. 3 is a block diagram showing a functional configuration of a learning unit of the image processing apparatus according to the first embodiment and the second embodiment.

FIG. 4 is a block diagram showing a functional configuration of an inference unit of the image processing apparatus according to the first embodiment and the second embodiment.

FIG. 5 is an image diagram of a difference area set for each layer.

FIG. 6 is a diagram for describing a difference area, an update area, and an update block.

FIG. 7 is an image diagram of a difference area set for each layer.

FIG. 8 is a flowchart showing a flow of learning processing of the first embodiment and the second embodiment.

FIG. 9 is a flowchart showing a flow of image processing of the first embodiment and the second embodiment.

FIG. 10 is a flowchart showing a flow of convolution processing in the image processing of the first embodiment.

FIG. 11 is a flowchart showing a flow of processing for setting update blocks of the first embodiment.

FIG. 12 is an image diagram of a difference area set for each layer and an update block set for each storage layer.

FIG. 13 is a diagram for describing a difference area, an update area, an update block, a processing target area, and a processing target block.

FIG. 14 is a flowchart showing a flow of convolution processing in the image processing of the second embodiment.

### DESCRIPTION OF EMBODIMENTS

An example of an embodiment of the disclosed technique will be described below with reference to the drawings. In the drawings, the same or equivalent components and portions are denoted by the same reference signs. Further, dimensional ratios in the drawings are exaggerated for convenience of description and thus may be different from actual ratios.

### Overview of Embodiment of Disclosed Technology

In the disclosed technology, the amount of calculation of CNN inference processing for each frame of a video is reduced by the following procedure.

First, the presence or absence of a difference between input images of a past frame and a current frame is determined in units of blocks of several pixels×several pixels, and a block including a difference area is subjected to normal CNN processing for one layer and is used as a processing result of a first layer. For other blocks that do not include a difference area, processing results of a first layer of a past frame are read and used as the processing results of the first layer. In subsequent layers, a difference area is expanded to a range affected by the difference area of the first layer, and normal CNN processing is performed on blocks that include the expanded difference area, and for blocks that do not include a difference area, CNN processing is skipped, and the processing results of the same layer of the past frame are read and used as the processing results of that layer. At this time, the difference area is updated based on criteria such as expanding the difference area one pixel at a time to the surrounding area in a layer using a 3×3 pixel kernel, and not expanding the difference area in a layer using a 1×1 pixel kernel. Furthermore, efficient implementation is possible by determining whether to perform CNN processing or to skip the CNN processing in units of predetermined blocks.

Regarding the above, the following methods can be used in combination.

A first method is to limit the storage of output feature maps of past frames to one of several layers among a plurality of layers to be subjected to convolution processing. Thus, except for storage layers where a reduction effect of a data transfer bandwidth and a memory capacity is obtained, since there is no feature map outside the difference area, and it is affected by invalid data from the surroundings due to convolution processing, normal CNN processing is performed over a correspondingly wider range. Furthermore, processing results affected by invalid data are discarded, and only processing results in areas that are not affected are overwritten over past frame results. Specifically, for each storage layer, a pixel width N at which the influence of the difference area is expanded up to the next storage layer is determined, and a block including at least a part of a update area obtained by expanding the difference area by N pixel width is set as an update block, and the feature map of the past frame is overwritten only for the update block. Further, a block including at least a part of a processing target area obtained by expanding the update area by N pixel width is set as a processing target block, and CNN processing is performed on the processing target block.

A second method is to determine in advance a range in which the final inference result is affected by the difference area of the first layer from a reduced image or inference results of past frames, and to prevent the difference area from expanding beyond the range, and then skip CNN processing outside the range and read the processing results of past frames. In this method, the effect of reducing the amount of calculation can be obtained by effectively limiting the area in which CNN processing is performed.

### First Embodiment

### <Configuration of Image Processing Apparatus According to First Embodiment>

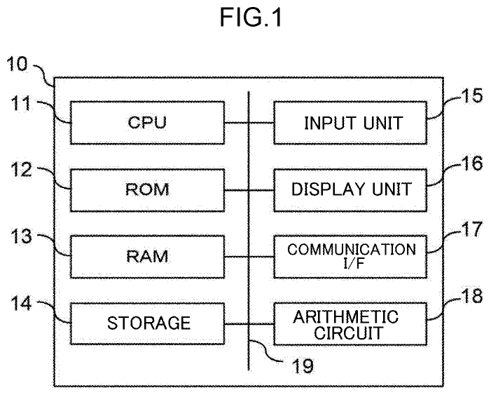

FIG. 1 is a block diagram showing a hardware configuration of an image processing apparatus 10 according to a first embodiment.

As shown in FIG. 1, the image processing apparatus 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit, which executes various programs and controls each unit. That is, the CPU 11 reads out the programs from the ROM 12 or the storage 14 and executes the programs by using the RAM 13 as a work area. The CPU 11 controls each component described above and performs various types of arithmetic processing according to the programs stored in the ROM 12 or the storage 14. In the present embodiment, the ROM 12 or the storage 14 stores a learning processing program for performing learning processing of a neural network and an image processing program for performing image processing using the neural network. The learning processing program and the image processing program may be one program, or may be a program group including a plurality of programs or modules.

The ROM 12 stores various programs and various types of data. The RAM 13 as a work area temporarily stores programs or data. The storage 14 is constituted by a hard disk drive (HDD) or a solid state drive (SSD), and stores various programs including an operating system and various types of data.

The input unit 15 includes a pointing device such as a mouse and a keyboard and is used to perform various inputs.

The input unit 15 receives training data for training the neural network as an input. For example, the input unit 15 receives, as an input, training data including a moving image to be processed and a predetermined processing result for the moving image.

The input unit 15 also receives a moving image to be processed as an input.

The display unit 16 is, for example, a liquid crystal display and displays various types of information including processing results. The display unit 16 may function as the input unit 15 by employing a touch panel system.

The communication interface 17 is an interface for communicating with other devices, and uses standards such as Ethernet (registered trademark), FDDI, and Wi-Fi (registered trademark), for example.

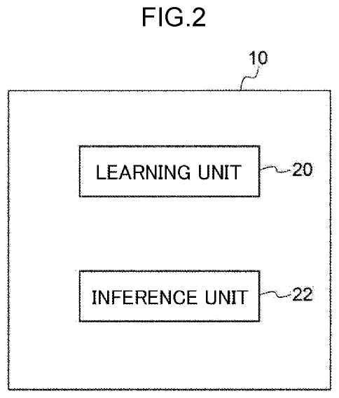

Next, a functional configuration of the image processing apparatus 10 will be described. FIG. 2 is a block diagram showing an example of the functional configuration of the image processing apparatus 10.

Functionally, the image processing apparatus 10 includes a learning unit 20 and an inference unit 22, as shown in FIG. 2.

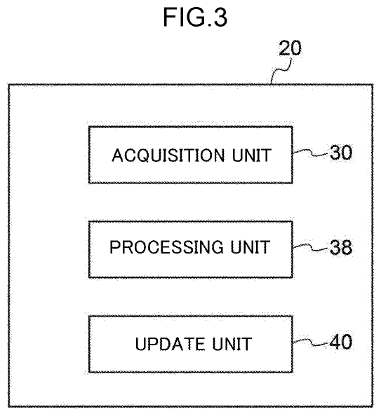

The learning unit 20 includes an acquisition unit 30, a processing unit 38, and an update unit 40, as shown in FIG. 3.

The acquisition unit 30 acquires a moving image of input training data and a processing result.

The processing unit 38 processes each frame of the moving image using a neural network including convolution processing.

The update unit 40 updates parameters of the neural network so that the result of processing the moving image using the neural network matches the processing result obtained in advance.

Each process of the processing unit 38 and the update unit 40 is repeatedly performed until a predetermined repetition end condition is satisfied. Thereby, the neural network is trained.

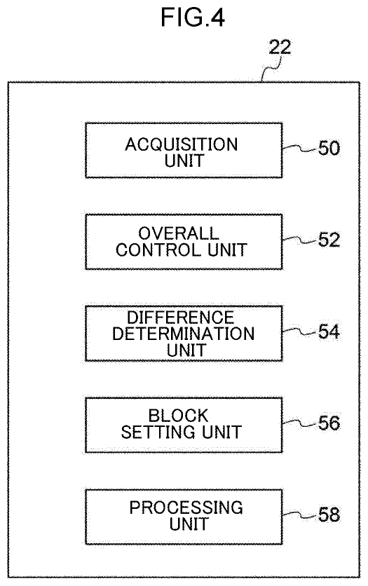

As shown in FIG. 4, the inference unit 22 includes an acquisition unit 50, an overall control unit 52, a difference determination unit 54, a block setting unit 56, and a processing unit 58.

The acquisition unit 50 acquires the input moving image to be processed.

The overall control unit 52 determines whether or not each of a plurality of frames of a moving image to be processed is a key frame. Here, it is assumed that a key frame is designated from a plurality of frames at a predetermined period. Note that a frame in which the proportion of the difference area is equal to or greater than a threshold value may be determined to be a key frame.

The difference determination unit 54 determines the difference area from the past frame for frames other than a key frame among the plurality of frames.

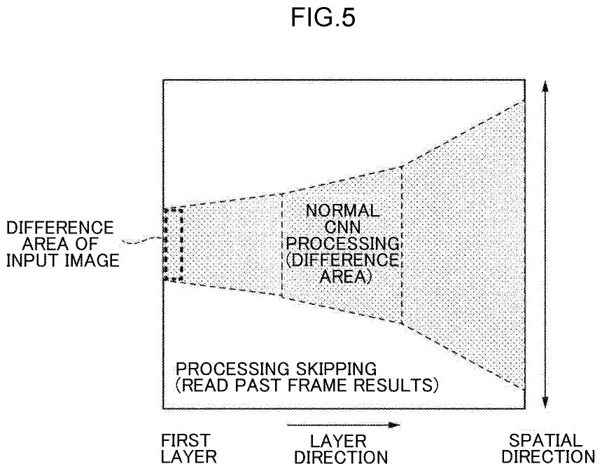

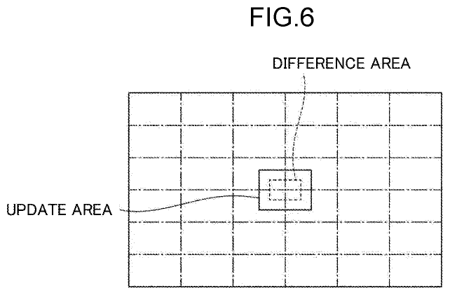

The block setting unit 56 sets, for the frames other than the key frame among the plurality of frames, an update block including at least a part of the update area according to the difference area among a plurality of blocks obtained by dividing an output feature map for each of the plurality of layers to be subjected to convolution processing of the neural network. At this time, the block setting unit 56 sets the difference area for each layer to be subjected to the convolution processing so that the difference area is expanded to the surrounding area from the previous layer according to the parameters of the convolution processing (see FIG. 5), and sets an update block including at least a part of the update area according to the difference area (see FIG. 6). FIG. 5 shows an example in which, compared to the difference area of the first layer, as the layer becomes deeper, the difference area is expanded, the range in which normal CNN processing is performed is expanded, and the range of reading processing results of past frames and performing processing skipping is reduced. Furthermore, FIG. 6 shows an example in which four blocks (dashed line rectangles) including at least partially an update area (solid line rectangle) in which a difference area (broken line rectangle) is expanded to a surrounding area are set as update blocks.

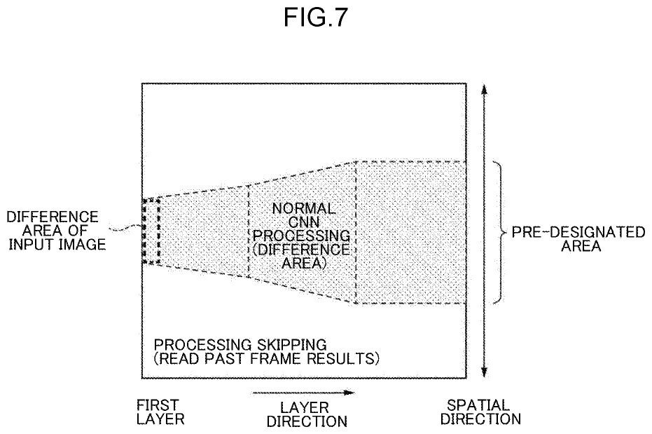

Further, it is preferable that the block setting unit 56 set the difference area so that the difference area is not expanded beyond a pre-designated area (see FIG. 7). Further, it is preferable that the block setting unit 56 set the difference area so that the difference area is not expanded in a layer after a pre-designated layer. FIG. 7 shows an example in which, compared to the difference area of the first layer, as the layer becomes deeper, the difference area is expanded up to the pre-designated area, and the range in which normal CNN processing is performed is not expanded after a layer that reaches the pre-designated area.

The processing unit 58 performs normal CNN inference processing for processing the frame using the neural network on the key frame among the plurality of frames, and stores the output feature map of each layer.

The normal CNN inference processing here refers to inputting an input feature map in each layer from the first layer to the final layer, performing convolution processing, activation function processing, down-sampling processing, up-sampling processing, and summing/connecting processing with output feature maps of other layers, and outputting an output feature map. Further, it is assumed that the input feature map of the first layer is image data including three channels of RGB, etc., and the output feature map of the final layer is data in which information regarding the inference result is stored in each channel. Further, in the following description, for convenience, it is assumed that a kernel size used for convolution is either 1×1 pixel or 3×3 pixel, but is not limited thereto.

Further, the processing unit 58 performs processing using a neural network on a block including a difference area for frames other than the key frame among the plurality of frames, and overwrites the stored output feature map.

The display unit 16 displays the results of processing the moving image using the neural network.

### <Operation of Image Processing Apparatus According to First Embodiment>

Next, the operation of the image processing apparatus 10 according to the first embodiment will be described.

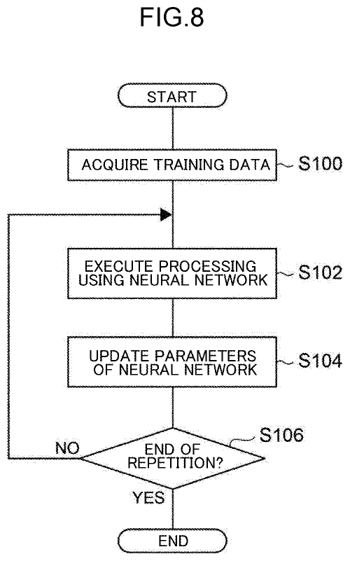

FIG. 8 is a flowchart showing a flow of learning processing by the image processing apparatus 10. The learning processing is performed by the CPU 11 reading out the learning processing program from the ROM 12 or the storage 14, loading the program into the RAM 13, and executing the program. Furthermore, training data is input to the image processing apparatus 10.

In step S100, the CPU 11, as the acquisition unit 30, acquires a moving image of the input training data and a processing result.

In step S102, the CPU 11, as the processing unit 38, processes the moving image of the training data using a neural network including convolution processing.

In step S104, the CPU 11, as the update unit 40, the updates parameters of the neural network so that the result of processing the moving image of training data using the neural network matches the processing result obtained in advance.

In step S106, the CPU 11 determines whether or not a predetermined repetition end condition is satisfied. When the repetition end condition is not satisfied, the process returns to step S102 above, and the processes of the processing unit 38 and the update unit 40 are repeatedly performed. Thereby, the neural network is trained.

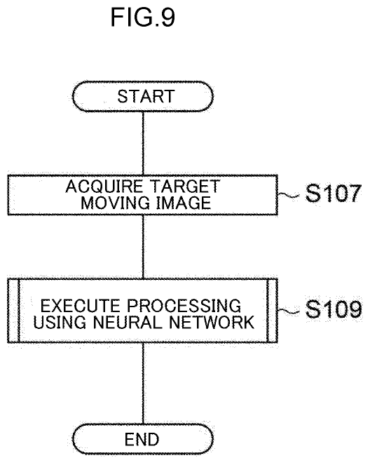

FIG. 9 is a flowchart showing a flow of image processing by the image processing apparatus 10. The image processing is performed by the CPU 11 reading out the image processing program from the ROM 12 or the storage 14, loading the program into the RAM 13, and executing the program. Furthermore, a moving image to be processed is input to the image processing apparatus 10.

In step S107, the CPU 11, as the acquisition unit 50, acquires the input moving image.

In step S109, the CPU 11 processes the moving image using the neural network trained by the learning processing described above. Then, the display unit 16 displays the results of processing the moving image using the neural network.

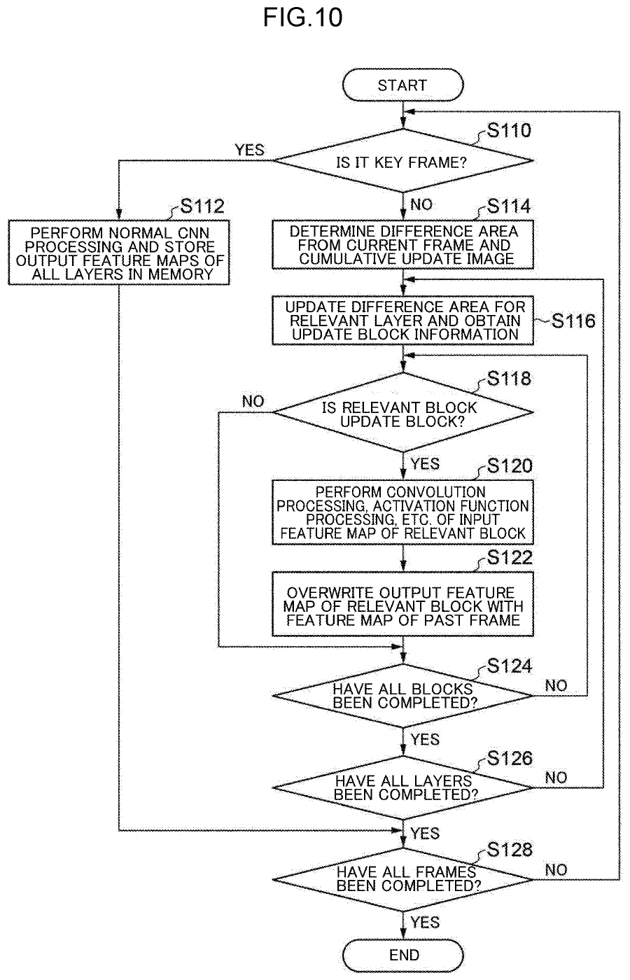

The above step S109 is implemented by the processing routine shown in FIG. 10. Here, each frame of the moving image is set as the current frame in order.

First, in step S110, the CPU 11, as the overall control unit 52, determines whether or not the current frame is a key frame. When it is determined that the current frame is a key frame, the process proceeds to step S112. On the other hand, when it is determined that the current frame is not a key frame, the process proceeds to step S114.

In step S112, the CPU 11, as the processing unit 58, performs normal CNN inference processing on the current frame, and stores all output feature maps of each layer in the RAM 13. Further, the inference result is output from the processing unit 58 to the display unit 16.

In step S114, the CPU 11, as the difference determination unit 54, calculates a pixel difference between an image of the current frame and a cumulative update image and determines the difference area. Here, the cumulative update image is an image in which areas determined to have a difference in each subsequent frame are replaced with the input image of that frame with respect to the image of the key frame. In the determination of the difference area, the influence of noise is removed by threshold processing of pixel difference values of both images, comparison processing with surrounding pixels, etc., and only areas where there is a visually significant difference are determined in units of pixels as difference areas.

In step S116, the CPU 11, as the block setting unit 56, sets a difference area for the relevant layer so that the difference area is expanded to the surrounding area from the previous layer according to the parameters of the convolution processing, sets an update area by expanding the difference area by one pixel width or several pixel widths as a margin, determines whether or not each block of several pixels square includes at least a part of the update area, sets a block including at least a part of the update area as an update block, and stores it in the RAM 13 as update block information.

In steps S118 and S120, the CPU 11, as the processing unit 58, performs processing for one layer on the basis of the update block information read from the RAM 13. Specifically, in step S118, the CPU 11, as the processing unit 58, determines whether or not the relevant block is an update block. When the relevant block is not an update block, the process proceeds to step S124 without performing any processing. Thus, for the relevant block, the output feature map of the past frame is directly used as the output feature map of the current frame.

On the other hand, when the relevant block is an update block, the process proceeds to step S120. In step S120, the CPU 11, as the processing unit 58, reads an input feature map including surrounding pixels necessary for convolution processing for the update block, and performs convolution processing and activation function processing on the result in the same manner as normal CNN inference processing.

In step S122, the CPU 11, as the processing unit 58, overwrites the output feature map for the update block with the output feature map at the same layer and the same position in the past frame on the RAM 13.

In step S124, the CPU 11 determines whether or not the processing of steps S118 to S122 above has been completed for all blocks. When there is a block that has not been processed in steps S118 to S122, the process returns to step S118 above, and the processing of steps S118 to S122 above is performed for the relevant block.

In step S126, the CPU 11 determines whether or not the processing of steps S116 to S124 above has been completed for all layers. When the processing of steps S116 to S124 above has not been completed for all layers, the process returns to step S116 above and the next layer is processed. On the other hand, when the processing of steps S116 to S124 above has been completed for all layers, the process proceeds to step S128.

In step S128, the CPU 11 determines whether or not the processing of steps S110 to S126 above has been completed for all frames. When the processing of steps S110 to S126 above has not been completed for all frames, the process returns to step S110 above and the next frame is processed as the current frame. On the other hand, when the processing of steps S110 to S126 above has been completed for all frames, the relevant processing routine ends.

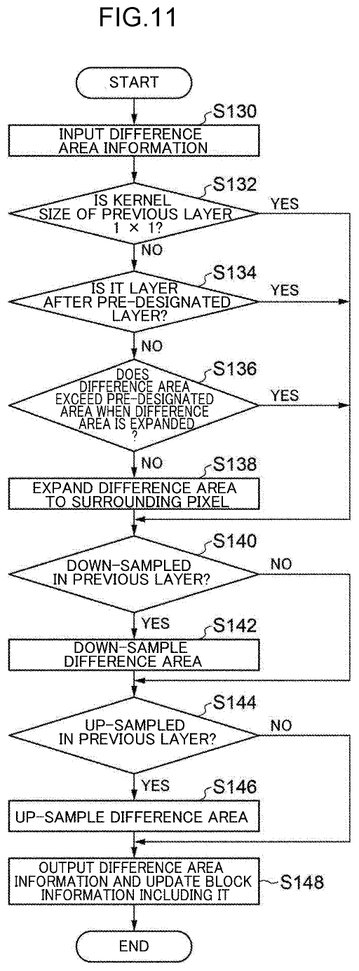

The above step S116 is implemented by the processing routine shown in FIG. 11.

First, in step S130, the CPU 11, as the block setting unit 56, acquires information indicating the determination result of the difference area in step S114 above.

In step S132, the CPU 11, as the block setting unit 56, determines whether or not a kernel size of the previous layer is 1×1. When the kernel size of the previous layer is 1×1, the process proceeds to step S140. On the other hand, when the kernel size of the previous layer is not 1×1 but 3×3, the process proceeds to step S134.

In step S134, the CPU 11, as the block setting unit 56, determines whether or not the relevant layer is a layer after a pre-designated layer. When the relevant layer is a layer after a pre-designated layer, the process proceeds to step S140. On the other hand, the relevant layer is a layer before a pre-designated layer, the process proceeds to step S136.

In step S136, the CPU 11, as the block setting unit 56, determines, for the relevant layer, whether or not the difference area exceeds a pre-designated area when the difference area is expanded to the surrounding area from the previous layer according to the parameters of the convolution processing. When it is determined that the difference area exceeds the pre-designated area when the difference area is expanded to the surrounding area from the previous layer, the process proceeds to step S140. On the other hand, when it is determined that the difference area does not exceed the pre-designated area when the difference area is expanded to the surrounding area from the previous layer, the process proceeds to step S138.

As a result of the determination in step S134 above, the difference area is not expanded to the surrounding area in a layer after the pre-designated layer. Further, even if it is a layer before the designated layer, the difference area is not expanded outside the pre-designated area based on the determination in step S136 above. This prevents update blocks from spreading over the entire feature map and reduces the amount of calculations.

Note that this is effective when it is known in advance that local changes within the image will not affect the inference results over a wider range, for example, when it is known in advance that only a relatively small object appears in the image or when it can be determined in advance from information such as other inference results that there is no change in the inference result outside the designated area.

In step S138, the CPU 11, as the block setting unit 56, expands the difference area by one pixel to the surrounding area. This is because when the kernel size of the convolution processing in the immediately preceding layer is larger than 1×1 pixel, the influence of the difference area is expanded to the surrounding area.

In step S140, the CPU 11, as the block setting unit 56, determines whether or not the previous layer involves down-sampling by ½. When the previous layer does not involve down-sampling by ½, the process proceeds to step S144. On the other hand, when the previous layer involves down-sampling by ½, the process proceeds to step S142.

In step S142, the CPU 11, as the block setting unit 56, down-samples the difference area to ½ in units of pixels. At this time, when there is a difference area of one or more pixels in 2×2 pixel, it is regarded as a difference area.

In step S144, the CPU 11, as the block setting unit 56, determines whether or not the previous layer involves up-sampling. When the previous layer does not involve up-sampling, the process proceeds to step S148. On the other hand, when the previous layer involves up-sampling, the process proceeds to step S146.

In step S146, the CPU 11, as the block setting unit 56, up-samples the difference area in units of pixels.

In step S148, the CPU 11, as the block setting unit 56, sets an update area by expanding the difference area by one pixel width or several pixel widths as a margin, determines whether or not each block of several pixels square includes at least a part of the update area, sets a block including at least a part of the update area as an update block, and stores it in the RAM 13 as update block information. The updated difference area information is also output to the RAM 13. The difference area information may be information in units of pixels, or may be a combination of information in units of blocks and information on pixel widths expanded from the information in units of blocks.

As described above, the image processing apparatus according to the first embodiment determines a difference area from a past frame for frames other than a key frame, sets an update block including an update area according to the difference area for each of a plurality of layers to be subjected to convolution processing, and overwrites an output feature map stored for the update block. In addition, the image processing apparatus sets the difference area for each layer to be subjected to the convolution processing so that the difference area is expanded to a surrounding area from a previous layer according to parameters of the convolution processing, and sets the update block including the update area according to the difference area. Thereby, it is possible to suppress the amount of calculation of processing using a neural network including convolution processing with a simple configuration.

Note that in the above embodiment, the case where the difference determination is performed not on the immediately preceding frame but on the cumulative update image was described as an example. However, this is to avoid a decrease in accuracy due to accumulation of small differences when a determination of no difference occurs for a plurality of consecutive frames in the same area. Therefore, the difference determination may be performed on the immediately preceding frame, and key frames may be inserted more frequently instead. Further, the difference determination may be performed using a reduced image of the input image in order to reduce the amount of calculations and reduce the influence of noise.

### Second Embodiment

Next, a second embodiment will be described. Note that since an image processing apparatus according to the second embodiment has the same configuration as the first embodiment, the same reference numerals are given and the description thereof will be omitted.

In the first embodiment, the output feature maps of all layers of past frames were stored in RAM and overwritten and updated, but the second embodiment differs from the first embodiment in that the layer in which the output feature map is stored in the RAM is limited in order to reduce memory capacity and bandwidth.

### <Configuration of Image Processing Apparatus According to Second Embodiment>

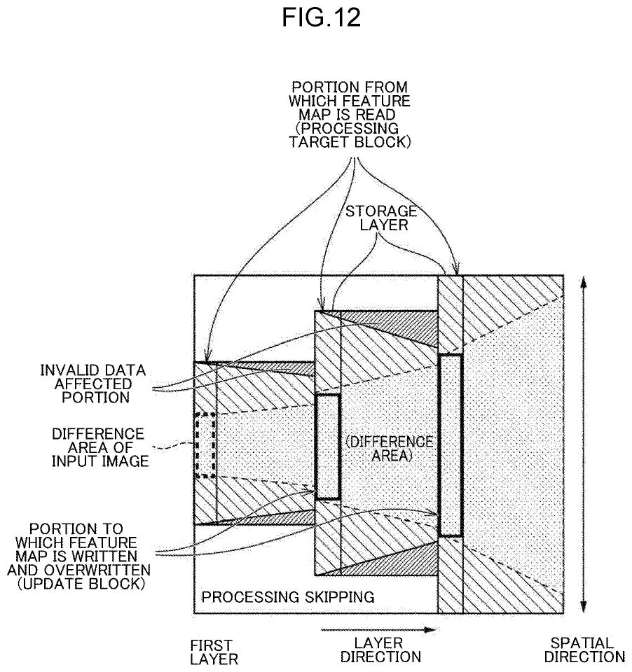

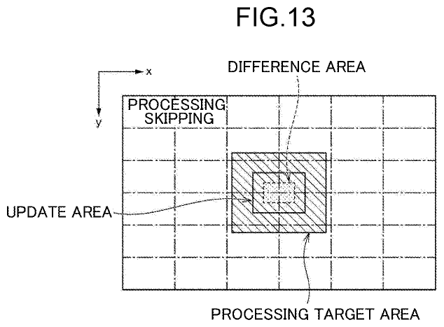

The block setting unit 56 of the image processing apparatus 10 according to the second embodiment sets, for frames other than a key frame among a plurality of frames, an update block including the update area according to the difference area among a plurality of blocks obtained by dividing an output feature map for each of predetermined storage layers of the plurality of layers to be subjected to convolution processing of the neural network. At this time, the block setting unit 56 sets the difference area for each of the predetermined storage layers so that the difference area is expanded to the surrounding area from the previous layer according to the parameters of the convolution processing (FIG. 12), and sets an update block including the update area according to the difference area (FIG. 13). Further, the block setting unit 56 sets a processing target block including a processing target area according to the difference area for each layer subjected to the convolution processing (FIG. 13).

FIG. 12 shows an example in which, compared to the difference area of the first layer, as the layer becomes deeper, the difference area is expanded, the range in which normal CNN processing is performed is expanded, and the range of reading processing results of past frames and performing processing skipping is reduced. Furthermore, an example is shown in which an update block for writing and overwriting a feature map is set for each storage layer. Furthermore, an example is shown in which the difference area is expanded in consideration of the portion affected by invalid data, and the processing target block, which is the portion from which the feature map is read, is set.

Furthermore, FIG. 13 shows an example in which four blocks (dashed line rectangles) including at least partially an update area (innermost solid line rectangle) in which a difference area (broken line rectangle) is expanded to a surrounding area are set as update blocks. Furthermore, an example is shown in which six blocks (broken line rectangles) including at least partially a processing target area (outer solid line rectangle) in which the difference area is further expanded to a surrounding area are set as processing target blocks.

Further, it is preferable that the block setting unit 56 set the difference area so that the difference area is not expanded beyond a pre-designated area. Further, it is preferable that the block setting unit 56 set the difference area so that the difference area is not expanded in a layer after a pre-designated layer.

The processing unit 58 performs normal CNN inference processing for processing the frame using the neural network on the key frame among the plurality of frames, and stores the output feature map of each storage layer.

Furthermore, the processing unit 58 performs, for the frames other than the key frame among the plurality of frames, processing using the neural network on the processing target block for each of the plurality of layers to be subjected to the convolution processing, and overwrites the update block of the output feature map stored for each of the storage layers.

### <Operation of Image Processing Apparatus According to Second Embodiment>

Next, the operation of the image processing apparatus 10 according to the second embodiment will be described. Note that processes similar to those in the first embodiment are given the same reference numerals and descriptions thereof will be omitted.

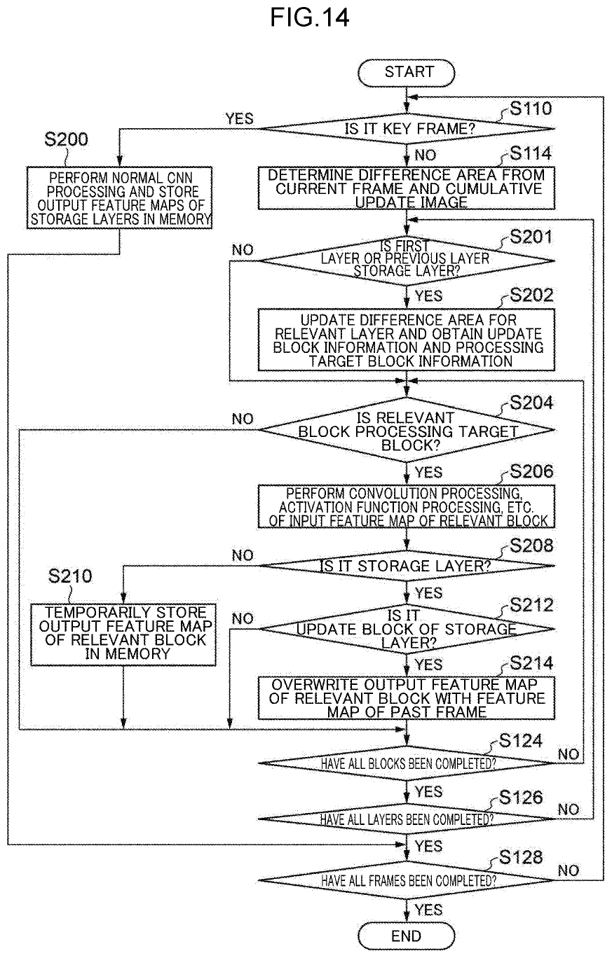

In the image processing apparatus 10, the learning processing shown in FIG. 8 is performed. Further, in the image processing apparatus 10, the image processing shown in FIG. 9 above is performed. At this time, the step S109 above is implemented by the processing routine shown in FIG. 14. Here, each frame of the moving image is set as the current frame in order.

First, in step S110, the CPU 11, as the overall control unit 52, determines whether or not the current frame is a key frame. When it is determined that the current frame is a key frame, the process proceeds to step S200. On the other hand, when it is determined that the current frame is not a key frame, the process proceeds to step S114.

In step S200, the CPU 11, as the processing unit 58, performs normal CNN inference processing on the current frame, and stores all output feature maps of each storage layer in the RAM 13. Further, the inference result is output from the processing unit 58 to the display unit 16.

In step S114, the CPU 11, as the difference determination unit 54, calculates a pixel difference between an image of the current frame and a cumulative update image and determines the difference area.

In step S201, the CPU 11 determines whether or not the relevant layer is the first layer or the previous layer is the storage layer. When the relevant layer is the first layer or the previous layer is the storage layer, the process proceeds to step S202. On the other hand, when the relevant layer is not the first layer and the previous layer is not the storage layer, the process proceeds to step S204.

In step S202, the CPU 11, as the block setting unit 56, sets a difference area for each layer up to the next storage layer so that the difference area is expanded to the surrounding area from the previous layer according to the parameters of the convolution processing, sets an update area for the next storage layer by expanding the difference area by one pixel width or several pixel widths as a margin, determines whether or not each block of several pixels square includes at least a part of the update area, sets a block including at least a part of the update area as an update block, and stores it in the RAM 13 as update block information. In addition, for each layer up to the next storage layer, the difference area is further expanded to set a processing target area, it is determined whether or not each block includes at least a part of the processing target area, and a block including at least a part of the processing target area is set as a processing target block, and is stored in the RAM 13 as processing target block information.

For example, the number N of layers with a kernel size of 3×3 pixels up to the next storage layer is acquired, an area where the difference area is expanded by N pixel width is set as the difference area in the next storage layer, an update area is set by expanding the difference area by one pixel width or several pixel widths as a margin, and a block including at least a part of the update area is set as an update block. Further, for each layer up to the next storage layer, a processing target area is set by further expanding the difference area, and a block including at least a part of the processing target area is set as a processing target block.

In addition, this is because in areas other than the storage layer, the input feature map outside the update block does not exist and invalid data is referenced, and the influence of invalid data erodes from the surrounding area by N pixel width, and thus it is necessary to process a correspondingly wider area.

Furthermore, when a down-sample or an up-sample is included before the next storage layer, the range of the update block or the processing target block is calculated by down-sampling or up-sampling the difference area in addition to expanding the difference area.

In step S204, the processing unit 58 determines whether or not the relevant block is a processing target block. When the relevant block is a processing target block, the process proceeds to step S206. On the other hand, when the relevant block is not a processing target block, the process proceeds to step S124.

In step S206, the CPU 11, as the processing unit 58, reads an input feature map including surrounding pixels necessary for convolution processing from the RAM 13, and performs convolution processing of the input feature map and activation function processing on the result in the same manner as normal CNN inference processing. No processing is performed for other blocks. Here, when surrounding pixel data of the processing target block is not stored in the memory, invalid data is read.

In step S208, the CPU 11, as the processing unit 58, determines whether or not the relevant layer is a storage layer. When the relevant layer is not a storage layer, the process proceeds to step S210. On the other hand, when the relevant layer is a storage layer, the process proceeds to step S212.

In step S210, the output feature map of the processing target block is temporarily stored in the RAM 13. This output feature map of the processing target block is stored until the next layer is processed.

In step S212, the CPU 11, as the processing unit 58, determines whether or not the relevant block is an update block of the storage layer. When the relevant block is not an update block of the storage layer, the process proceeds to step S124 without performing any processing. Thus, for the relevant block, the output feature map of the past frame is directly used as the output feature map of the current frame. On the other hand, when the relevant block is an update block, the process proceeds to step S214.

In step S214, the CPU 11, as the processing unit 58, overwrites the output feature map for the update block of the storage layer with the output feature map at the same layer and the same position in the past frame on the RAM 13.

In step S124, the CPU 11 determines whether or not the processing of steps S204 to S214 above has been completed for all blocks. When there is a block that has not been processed in steps S204 to S214, the process returns to step S204 above, and the processing of steps S204 to S214 above is performed for the relevant block.

In step S126, the CPU 11 determines whether or not the processing of steps S201 to S214 and S124 above has been completed for all layers. When the processing of steps S201 to S214 and S124 above has not been completed for all layers, the process returns to step S201 above and the next layer is processed. On the other hand, when the processing of steps S201 to S214 and S124 above has been completed for all layers, the process proceeds to step S128.

In step S128, the CPU 11 determines whether or not the processing of steps S110 to S126 above has been completed for all frames. When the processing of steps S110 to S126 above has not been completed for all frames, the process returns to step S110 above and the next frame is processed as the current frame. On the other hand, when the processing of steps S110 to S126 above has been completed for all frames, the relevant processing routine ends.

The above step S202 is implemented by a processing routine similar to the processing routine shown in FIG. 11 for each layer up to the next storage layer. However, in step S148, the CPU 11, as the block setting unit 56, sets an update area by expanding the difference area by one pixel width or several pixel widths as a margin, determines whether or not each block of several pixels square includes at least a part of the update area, sets a block including at least a part of the update area as an update block, and stores it in the RAM 13 as update block information. In addition, the CPU 11, as the block setting unit 56, expands the difference area further than the update area to set a processing target area, determines whether or not each block includes at least a part of the processing target area, sets a block including at least a part of the processing target area as a processing target block, and stores it in the RAM 13 as processing target block information.

Note that other configurations and functions of the image processing apparatus according to the second embodiment are the same as those in the first embodiment, and therefore, description thereof will be omitted.

As described above, the image processing apparatus according to the second embodiment determines a difference area from a past frame for frames other than a key frame, sets an update block including an update area according to the difference area for each of predetermined storage layers, sets a processing target block including a processing target area according to the difference area for each of a plurality of layers, performs processing using a neural network on the processing target block for each of the plurality of layers, and overwrites the update block of an output feature map stored for each of the storage layers. In addition, the image processing apparatus sets the difference area for each storage layer so that the difference area is expanded to a surrounding area from a previous layer according to parameters of the convolution processing, and sets the update block including the update area according to the difference area. Thereby, it is possible to suppress the amount of calculation of processing using a neural network including convolution processing with a simple configuration.

Note that the present invention is not limited to the apparatus configuration and operation of the embodiments described above, and various modifications and applications are possible without departing from the gist of the present invention.

For example, although the kernel size used for convolution has been described as either 1×1 pixel or 3×3 pixel, the present invention is not limited thereto. Kernel sizes other than these may also be used. For example, the kernel size used for convolution may be 5×5 pixel or 7×7 pixel. In this case, it is sufficient that, when the kernel size used in the previous layer is 5×5 pixel, the difference area is expanded two pixels at a time to the surrounding area, and when the kernel size used in the previous layer is 7×7 pixel, the difference area is expanded three pixels at a time to the surrounding area.

Further, although the image processing apparatus has been described as an example including a learning unit and an inference unit, the present invention is not limited thereto. The apparatus including a learning unit and the apparatus including an inference unit may be configured as separate apparatuses. When hardware constraints such as power and size are large, it is preferable to configure the apparatus including a learning unit and the apparatus including an inference unit as separate apparatuses.

Further, the various types of processing executed in a case where the CPU reads software (program) in the above embodiment may be executed by various processors other than the CPU. Examples of processors used in such cases include a programmable logic device (PLD) such as a field-programmable gate array (FPGA) of which a circuit configuration can be changed after manufacturing and a dedicated electrical circuit that is a processor having a circuit configuration such as an application specific integrated circuit (ASIC) that is designed to execute specific processing. In addition, the learning processing and the image processing may be executed by one of these various processors, or may be executed by a combination of two or more processors of the same type or different types (for example, a plurality of FPGAs, a combination of a CPU and an FPGA, and the like). Furthermore, a hardware structure of the various processors is, more specifically, an electrical circuit in which circuit elements such as semiconductor elements are combined.

Further, in each embodiment described above, the aspect in which the learning processing program and the image processing program are stored (installed) in advance in the storage 14 has been described, but the present invention is not limited thereto. The program may be provided in a form stored in a non-transitory storage medium such as a compact disk read only memory (CD-ROM), a digital versatile disc read only memory (DVD-ROM), and a Universal Serial Bus (USB) memory. Further, the program may be downloaded from an external device via a network.

Regarding the above embodiment, the following supplementary notes are further disclosed.

### (Supplementary Note 1)

An image processing apparatus including a neural network including convolution processing for a moving image including a plurality of frames, the image processing apparatus including:
a memory; and
at least one processor connected to the memory,
in which the processor is configured to:
acquire a moving image to be processed;
determine a difference area from a past frame for frames other than a key frame among the plurality of frames;
set, for the frames other than the key frame among the plurality of frames, an update block including an update area according to the difference area among a plurality of blocks obtained by dividing an output feature map for each of a plurality of layers to be subjected to the convolution processing of the neural network;
process, for the key frame among the plurality of frames, the key frame using the neural network, and store an output feature map of each layer; and
process, for the frames other than the key frame among the plurality of frames, the frames using the neural network, and overwrite an output feature map stored for the update block, and
the setting of the update block includes setting the difference area for each layer to be subjected to the convolution processing so that the difference area is expanded to a surrounding area from a previous layer according to parameters of the convolution processing, and setting the update block including the update area according to the difference area.

### (Supplementary Note 2)

A non-transitory storage medium storing a computer-executable program including a neural network including convolution processing for a moving image including a plurality of frames to execute image processing,
in which the image processing includes:
acquiring a moving image to be processed;
determining a difference area from a past frame for frames other than a key frame among the plurality of frames;
setting, for the frames other than the key frame among the plurality of frames, an update block including an update area according to the difference area among a plurality of blocks obtained by dividing an output feature map for each of a plurality of layers to be subjected to the convolution processing of the neural network;
processing, for the key frame among the plurality of frames, the key frame using the neural network, and storing an output feature map of each layer; and
processing, for the frames other than the key frame among the plurality of frames, the frames using the neural network, and overwriting an output feature map stored for the update block, and
the setting of the update block includes setting the difference area for each layer to be subjected to the convolution processing so that the difference area is expanded to a surrounding area from a previous layer according to parameters of the convolution processing, and setting the update block including the update area according to the difference area.

### (Supplementary Note 3)

An image processing apparatus including a neural network including convolution processing for a moving image including a plurality of frames, the image processing apparatus including:
a memory; and
at least one processor connected to the memory,
in which the processor is configured to:
acquire a moving image to be processed;
determine a difference area from a past frame for frames other than a key frame among the plurality of frames;
set, for the frames other than the key frame among the plurality of frames, an update block including an update area according to the difference area among a plurality of blocks obtained by dividing an output feature map for each of predetermined storage layers among a plurality of layers to be subjected to the convolution processing of the neural network, and set a processing target block including a processing target area according to the difference area for each of the plurality of layers;
process, for the key frame among the plurality of frames, the key frame using the neural network, and store an output feature map of each of the storage layers; and
perform, for the frames other than the key frame among the plurality of frames, processing using the neural network on the processing target block for each of the plurality of layers, and overwrite the update block of the output feature map stored for each of the storage layers, and the setting of the update block includes setting the difference area for each of the storage layers so that the difference area is expanded to a surrounding area from a previous layer according to parameters of the convolution processing, and setting the update block including the update area according to the difference area.

### (Supplementary Note 4)

A non-transitory storage medium storing a computer-executable program including a neural network including convolution processing for a moving image including a plurality of frames to execute image processing,
in which the image processing includes:
acquiring a moving image to be processed;
determining a difference area from a past frame for frames other than a key frame among the plurality of frames;
setting, for the frames other than the key frame among the plurality of frames, an update block including an update area according to the difference area among a plurality of blocks obtained by dividing an output feature map for each of predetermined storage layers among a plurality of layers to be subjected to the convolution processing of the neural network, and setting a processing target block including a processing target area according to the difference area for each of the plurality of layers;
processing, for the key frame among the plurality of frames, the key frame using the neural network, and storing an output feature map of each of the storage layers; and
performing, for the frames other than the key frame among the plurality of frames, processing using the neural network on the processing target block for each of the plurality of layers, and overwriting the update block of the output feature map stored for each of the storage layers, and
the setting of the update block includes setting the difference area for each of the storage layers so that the difference area is expanded to a surrounding area from a previous layer according to parameters of the convolution processing, and setting the update block including the update area according to the difference area.

### REFERENCE SIGNS LIST

10 Image processing apparatus
11 CPU
13 RAM
14 Storage
15 Input unit
16 Display unit
20 Learning unit
22 Inference unit
30 Acquisition unit
38 Processing unit
40 Update unit
50 Acquisition unit
52 Overall control unit
54 Difference determination unit
56 Block setting unit
58 Processing unit

1. An image processing apparatus including a neural network including convolution processing for a moving image including a plurality of frames, the image processing apparatus comprising:
a memory; and
at least one processor coupled to the memory, the at least one processor being configured to:
acquire a moving image to be processed;
determine a difference area from a past frame, for frames other than a key frame among the plurality of frames;
set, for the frames other than the key frame, an update block including an update area, according to the difference area, among a plurality of blocks obtained by dividing an output feature map for each of a plurality of layers to be subjected to the convolution processing of the neural network; and
process the key frame using the neural network, and store an output feature map of each layer, and
process the frames other than the key frame using the neural network, and overwrite an output feature map stored for the update block,
wherein the at least one processor sets the difference area for each layer to be subjected to the convolution processing so that the difference area is expanded to a surrounding area from a previous layer, according to parameters of the convolution processing, and sets the update block including the update area, according to the difference area.

2. An image processing apparatus including a neural network including convolution processing for a moving image including a plurality of frames, the image processing apparatus comprising:
a memory; and
at least one processor coupled to the memory, the at least one processor being configured to:
acquire a moving image to be processed;
determine a difference area from a past frame, for frames other than a key frame among the plurality of frames;
set, for the frames other than the key frame, an update block including an update area, according to the difference area, among a plurality of blocks obtained by dividing an output feature map for each of predetermined storage layers among a plurality of layers to be subjected to the convolution processing of the neural network, and set a processing target block including a processing target area, according to the difference area, for each of the plurality of layers; and
process the key frame using the neural network, and store an output feature map of each of the storage layers, and
perform, for the frames other than the key frame, processing using the neural network on the processing target block for each of the plurality of layers, and overwrite the update block of the output feature map stored for each of the storage layers,
wherein the at least one processor sets the difference area for each of the storage layers so that the difference area is expanded to a surrounding area from a previous layer, according to parameters of the convolution processing, and sets the update block including the update area, according to the difference area.

3. The image processing apparatus according to claim 1, wherein the at least one processor sets the difference area so that the difference area is not expanded beyond a pre-designated area.

4. The image processing apparatus according to claim 2, wherein the at least one processor sets the difference area so that the difference area is not expanded beyond a pre-designated area.

5. The image processing apparatus according to claim 1, wherein the at least one processor sets the difference area so that the difference area is not expanded in a layer after a pre-designated layer.

6. An image processing method in an image processing apparatus including a neural network including convolution processing for a moving image including a plurality of frames, the image processing method comprising:
acquiring a moving image to be processed;
determining a difference area from a past frame, for frames other than a key frame among the plurality of frames;
setting, for the frames other than the key frame, an update block including an update area, according to the difference area, among a plurality of blocks obtained by dividing an output feature map for each of a plurality of layers to be subjected to the convolution processing of the neural network;
processing the key frame using the neural network, and storing an output feature map of each layer; and
processing for the frames other than the key frame, the frames using the neural network, and overwriting the output feature map stored for the update block,
wherein the setting of the update block includes setting the difference area for each layer to be subjected to the convolution processing so that the difference area is expanded to a surrounding area from a previous layer, according to parameters of the convolution processing, and setting the update block including the update area, according to the difference area.

7. (canceled)

8. (canceled)
